(19) United States
(12) Patent Application Publication
(10) Pub. No.: US 2026/0234363 A1
(43) Pub. Date: Aug. 13, 2026

(54) RUBBER COMPOSITION

(71) Applicant: UPM-KYMMENE CORPORATION, Helsinki (FI)

(72) Inventors: Florian DIEHL, Helsinki (FI); Barbara GALL, Helsinki (FI); Maximilian WEBER, Helsinki (FI); Sanna VALKONEN, Helsinki (FI); Christian HÜBSCH, Helsinki (FI)

(21) Appl. No.: 19/474,993

(22) PCT Filed: Apr. 20, 2023
(86) PCT No.: PCT/EP2023/060231

§ 371 Date: Oct. 13, 2025

(51) Int. Cl. C08K 3/04; B60C 1/00; C08L 7/00; C08L 23/16

(52) U.S. Cl. CPC C08K 3/04; C08L 7/00; C08L 23/16; B60C 1/00; C08L 2205/06; C08L 2207/322

(57) ABSTRACT

A rubber composition is disclosed. The rubber composition may be made by using at least lignin-based filler and rubber, and optionally plasticizer. Further is disclosed an article comprising the rubber composition.

### FIELD OF THE INVENTION

The present disclosure relates to a rubber composition. Further, the present disclosure relates to an article comprising the rubber composition as disclosed in the current disclosure.

### BACKGROUND OF THE INVENTION

Rubber industry is mainly relying on fossil-based and heavily CO₂ intensive raw materials. As a result final articles like for example tires, profiles, sealings, and hoses, are carrying a quite high CO₂ load per article weight which significantly contributes to the overall carbon footprint of end user products, e.g. cars. Main drivers are typically the major share compound components, namely rubbers, functional fillers and plasticizers. The inventors have recognized the ongoing need to find sustainable solutions for different applications to reduce emissions.

### SUMMARY

A rubber composition is disclosed. The rubber composition is made by using at least lignin-based filler and rubber, and optionally plasticizer, wherein:
the lignin-based filler is prepared from lignin subjected to hydrothermal carbonization treatment;
the total amount of lignin-based filler in the rubber composition is 2-500 phr; and
the total biogenic carbon content of the rubber composition is 50-100% as determined according to standard ASTM D6866-22;
with the proviso that when no plasticizer is used for making the rubber composition, then at least one bio-based rubber is used; and when both rubber and plasticizer are used for making the rubber composition, then at least one bio-based rubber and/or at least one bio-based plasticizer are/is used.

Further is disclosed an article comprising the rubber composition as disclosed in the current disclosure.

### DETAILED DESCRIPTION

A rubber composition is disclosed. The rubber composition is made by using at least lignin-based filler, and rubber, and optionally plasticizer, wherein:
the lignin-based filler is prepared from lignin subjected to hydrothermal carbonization treatment;
the total amount of lignin-based filler in the rubber composition is 2-500 phr; and
the total biogenic carbon content of the rubber composition is 50-100% as determined according to standard ASTM D6866-22;
with the proviso that when no plasticizer is used for making the rubber composition, then at least one bio-based rubber is used; and when both rubber and plasticizer are used for making the rubber composition, then at least one bio-based rubber and/or at least one bio-based plasticizer are/is used.

In one embodiment, the proviso is that:
i) when no plasticizer is used for making the rubber composition, then the rubber comprises bio-based rubber;
ii) when plasticizer is used for making the rubber composition, then:
   the rubber comprises bio-based rubber and the plasticizer comprises bio-based plasticizer; or
   the rubber comprises bio-based rubber and the plasticizer comprises fossil-based plasticizer; or
   the rubber comprises fossil-based rubber and the plasticizer comprises bio-based plasticizer.

In one embodiment, the proviso is that:
i) when no plasticizer is used for making the rubber composition, then the rubber is bio-based rubber;
ii) when a plasticizer is used for making the rubber composition, then:
   the rubber is bio-based rubber and the plasticizer is bio-based plasticizer; or
   the rubber is bio-based rubber and the plasticizer is fossil-based plasticizer; or
   the rubber is fossil-based rubber and the plasticizer is bio-based plasticizer.

Further is disclosed an article comprising the rubber composition as disclosed in the current disclosure. The article may be a profile, a hose, a sealing, an O-ring, a weather strip, a gasket, a tubing, a membrane, an insulator, a cable, a wiper blade, a bushing, a tape, a foil, a lining, a flooring, a plug, a nipple, a conveyor belt, a seal or a tire.

Rubber is a type of material that may be produced from natural sources (e.g. natural rubber) or may be synthesized on an industrial scale (fossil-based rubber). Rubber is elastic, resilient, and tough, which makes it suitable as a basic constituent in e.g. tires used in automotive vehicles, aircraft, and bicycles. The main chemical constituents of rubber may be elastomers.

When no plasticizer is used for making the rubber composition, then at least one bio-based rubber is used. Thus, also a fossil-based rubber may be used for making the rubber composition in such a situation but at least one bio-based rubber is to be used. Thus, a mixture of a bio-based rubber and a fossil-based rubber may be used.

When both rubber and plasticizer are used for making the rubber composition, then at least one biobased rubber and/or at least one bio-based plasticizer are/is used. Thus, also a fossil-based rubber and/or a fossil-based plasticizer may be used for making the rubber composition in such a situation but at least one bio-based rubber and/or at least one bio-based plasticizer are/is to be used. Thus, a mixture of a bio-based rubber and a fossil-based rubber with a mixture of biobased plasticizer and a fossil-based plasticizer may be used.

In one embodiment, the rubber composition is made by using at least lignin-based filler and bio-based rubber. In one embodiment, the rubber composition is made by using at least lignin-based filler, bio-based rubber, and plasticizer. In one embodiment, the rubber composition is made by using at least lignin-based filler, fossil-based rubber, and bio-based plasticizer. In one embodiment, the rubber composition is made by using at least lignin-based filler, bio-based rubber, and bio-based plasticizer.

In one embodiment, no fossil-based rubber is used for making the rubber composition. In one embodiment, no fossil-based plasticizer is used for making the rubber composition. In one embodiment, no fossil-based rubber nor fossil-based plasticizer is used for making the rubber composition.

The use of the renewable lignin-based filler in the rubber composition has the added utility of offering superior environmental performance as its CO₂ footprint is even negative. Thus, the lignin-based filler may act as quasi CO₂ absorbers when replacing traditional functional fillers in rubber compositions. This effect may be even further boosted by the lightweight character of the lignin-based filler which results in lower final composition densities. This has a further positive contribution as rubber articles are often volume-based. Lower composition density thus means less amount of raw materials required per piece. Thus, the carbon footprint value of the rubber composition is reduced by at least 10%, or at least 20%, or at least 30%, or at least 40%, or at least 50%, or at least 60%, or at least 70%, or at least 80%, or at least 90%, or at least 100%, compared to a fossil-based rubber composition prepared in a similar manner as the rubber composition as defined in the current disclosure but by using only fossil-based components.

The rubber composition may exhibit a hardness value of 20-100, or 30-90, or 40-85, or 45-75, or 50-65, as determined according to standard ASTM D 2240-15 (2021). The rubber composition may exhibit a Mooney viscosity ML (1+4) 100° C. of 20-110 MU, or 25-100 MU, or 30-90 MU, or 35-95 MU, or 40-85 MU, or 45-75 MU, or 50-70 MU, or 55-65 MU as determined according to standard ASTM D 1646-19a. The inventors surprisingly noted that one is able to produce a rubber composition of highly bio-based origin with simultaneously properties such as hardness and Mooney viscosity remaining at a similar level as with fossil-based rubber compositions.

The total biogenic carbon content of the rubber composition may be 50-100%, 50-99%, or 60-98%, or 70-97%, or 80-96%, or 90-95%, as determined according to standard ASTM D6866-22. Biogenic carbon is the carbon that is stored in biological materials, such as plants or soil. Carbon accumulates in plants through the process of photosynthesis and thus bio-based products may contribute to reduce the levels of carbon dioxide in the atmosphere.

The total organic carbon content of the rubber composition may be 30-100%, 40-100%, 50-99%, 60-98% as determined according to DIN EN 15936:2012-11. The total organic carbon content of the rubber composition may be 90-100%, or 93-99%, or 96-98% as determined according to DIN EN 15936:2012-11. The term “total organic carbon (TOC)” may be taken as the amount of carbon found in an organic compound or in this case in the rubber composition. The rubber composition as disclosed in the current disclosure may thus have a high total organic carbon content.

The plasticizer used for making the rubber composition may be bio-based plasticizer or fossil-based plasticizer. The plasticizer(s) used in the rubber composition may be derived from fossil resource(s) and/or from biobased resource(s). Also a combination or a mixture of bio-based plasticizer(s) and fossil-based plasticizer(s) may be used for making the rubber composition. The bio-based plasticizer may be selected from bio-based oil, bio-based wax, or bio-based liquid polymer. The use of the bio-based plasticizer may increase the total biogenic carbon content of the rubber composition while simultaneously affecting the properties of the rubber composition.

The weight ratio of the total amount of plasticizer to the total amount of rubber may be 0-2, or 0.01-1.75, or 0.02-1.5.

The total amount of bio-based rubber in the rubber composition may be 0-100 phr, or 5-95 phr, or 10-90 phr. The total amount of bio-based rubber in the rubber composition may be 0-100 phr, or 5-95 phr, or 10-90 phr, or 20-80 phr, or 30-70 phr, or 40-60 phr, or 50-55 phr. The rest of the rubber may be fossil-based rubber.

In one embodiment, the weight ratio of the total amount of plasticizer to the total amount of lignin-based filler is 0-40, or 0.05-20, or 0.1-10, or 0.2-5, or 0.5-2.

In one embodiment, the total amount of lignin-based filler in the rubber composition is 2-500 phr, or 5-200 phr, or 10 phr-150 phr, or 20-100 phr, or 25-75 phr.

The term “phr” refers to “parts per hundred rubber”. Parts per hundred rubber is a measure commonly used by rubber chemists to depict what amount of certain ingredients are needed in a composition in relation to the total amount of rubber in the composition.

Further filler in addition to the lignin-based filler may be used for making the rubber composition. The further filler may be a fossil-based filler.

The rubber used for making the rubber composition may be bio-based rubber or fossil-based rubber. The rubber used in the rubber composition may be derived from fossil resource(s) and/or from biobased resource(s). Also a combination or a mixture of bio-based rubber(s) and fossil-based rubber(s) may be used for making the rubber composition.

The term “bio-based rubber” is used in this specification to refer to rubber derived from a bioresource. The term “bio-based rubber” may thus include rubber prepared by synthesis using bio-based raw materials and may also include natural rubber found from the nature. Bio-based rubber is an important way for the sustainable development of the rubber industry.

The (bio-based) rubber may be selected from ethylene propylene diene monomer rubber (EPDM), ethylene propylene rubber (EPR), butadiene rubber (BR), styrenebutadiene rubber (SBR), epichlorhydrin rubber (ECO), chloroprene rubber (CR), natural rubber (NR), epoxidized natural rubber (ENR), butyl rubber (IIR), isoprene rubber (IR), acrylonitrile-butadiene rubber (NBR), hydrogenated nitrile rubber (HNBR), bromobutyl rubber (BIIR) chlorobutyl rubber (CIIR) or any combination or mixture thereof.

The bio-based rubber may be selected from ethylene propylene diene monomer rubber (EPDM), ethylene propylene rubber (EPR), butadiene rubber (BR), styrenebutadiene rubber (SBR), epichlorhydrin rubber (ECO), chloroprene rubber (CR), natural rubber (NR), epoxidized natural rubber (ENR), butyl rubber (IIR), isoprene rubber (IR), acrylonitrile-butadiene rubber (NBR), hydrogenated nitrile rubber (HNBR), bromobutyl rubber (BIIR) chlorobutyl rubber (CIIR) or any combination or mixture thereof. In one embodiment, the bio-based rubber is a natural rubber or bio-based EDPM.

The fossil-based rubber may be selected from ethylene propylene diene monomer rubber (EPDM), ethylene propylene rubber (EPR), butadiene rubber (BR), styrenebutadiene rubber (SBR), epichlorhydrin rubber (ECO), chloroprene rubber (CR), epoxidized natural rubber (ENR), butyl rubber (IIR), isoprene rubber (IR), acrylonitrile-butadiene rubber (NBR), hydrogenated nitrile rubber (HNBR), bromobutyl rubber (BIIR) chlorobutyl rubber (CIIR) or any combination or mixture thereof. In one embodiment, the fossil-based rubber is fossil-based EPDM.

Any combination or mixture of the above rubbers may also be used. In one embodiment, the rubber is a mixture of bio-based rubber and fossil-based rubber. These rubbers may either be found in nature or they may be prepared by synthesizing from bioresources, or they have a fossil origin.

The rubber composition may be prepared by using at least rubber, lignin-based filler, and possibly plasticizer. Further components or materials, such as additives, lubricants, stabilizers, antioxidants, curing agents, blowing agents, etc., may also be used for preparing the rubber composition. In one embodiment, combining the rubber and the lignin-based filler comprises also combining one or more plasticizers, additives, lubricants, stabilizers, antioxidants, curing agents, and/or blowing agents, to form the rubber composition.

Also, one or more silane compounds may be used for making the rubber compositions. Examples of silane compounds are 3,3′-bis-(triethoxysilylpropyl)-tetrasulfide (TESPT), 3,3′-bis-(triethoxysilylpropyl)-disulfide (TESPD), 3-thiocyanato-propyltriethoxysilane, γ-mercaptopropyl-trimethoxysilane, vinyltriethoxysilane, chlorpropyltriethoxy-silane. Of these 3,3′-bis-(triethoxysilylpropyl)-tetrasulfide (TESPT) and 3,3′-bis-(triethoxysilylpropyl)-disulfide (TESPD) may be preferred ones to be used in the rubber composition. The total amount of silane compound(s) in the rubber composition may be 0.25-20 phr, or 0.5-16 phr, or 0.75-12 phr, or 1.0-10 phr, or 1.5-8 phr, or 2.0-6 phr, or 2.5-5 phr.

The rubber composition may be prepared by mixing or combining the above components according to conventional procedures.

The articles comprising the rubber composition can be obtained by mixing the rubber composition with possible other r components, compounding, and subsequently curing the same according to conventional procedures.

The article may in addition to the rubber composition contain additional filler(s) such as carbon black, precipitated silica, neuburg siliceous earth, and white fillers (talc, chalk, kaolin). The additional filler may be used in an amount of 5-200 phr, or 10-150 phr, or 15-125 phr, or 20-100 phr, or 25-75 phr.

The temperature used when combining the different components may vary depending on the type of rubber used. The suitable temperature to be used for each rubber is readily available to the person skilled in the art. Also the rubber providers define suitable for different rubbers processing temperatures Generally, temperatures of e.g. 20-350° C., or 40-330° C., or 70-300° C., or 120-280° C., or 150-250° C., may be used.

The rubber composition may be further cured at an elevated temperature in a subsequent step after mixing of the (bio-based) rubber, the lignin-based filler, and possibly the (bio-) plasticizer.

The density of the rubber composition may be 0.7-2.0 g/cm³, or 0.8-1.6 g/cm³, or 0.9-1.3 g/cm³, or 1.0-1.2 g/cm³ as determined according to ASTM D792-20. The use of the lignin-based filler for preparing the rubber composition has the added utility of being a lightweight material that thus affects the final weight and density of the produced rubber composition. This may have an added utility in end products requiring less weight.

In one embodiment, the ash content of the rubber composition is less than 25 weight-%, or less than 20 weight-%, or less than 15 weight-%, or less than 10 weight-%, or less than 5 weight-%, as determined according to DIN 51719:1997-07. Having a lower ash content has the added utility of affecting in a lowering manner the density and the weight of the rubber composition. Further, a high ash content may affect the bio-content of the rubber composition in an adverse manner.

The amount of renewable materials in the rubber composition may be 5-100%, or 10-95%, or 15-90%, or 20-85%.

The lignin-based filler that is used to make the rubber composition is a lignin-based filler prepared from lignin subjected to hydrothermal carbonization treatment (HTC). The hydrothermal carbonization treatment of lignin refers to a thermochemical conversion process of lignin-containing material in an aqueous suspension. Hydrothermal carbonization treatment of lignin produces lignin derivatives having high carbon content and functional groups.

Lignin is a biopolymer, that is a key structural material in the supporting tissues of most living plants. It is a renewable material which can be used in several applications.

The lignin may be derived from any suitable source. The lignin may be derived from e.g. wood, such as hardwood, softwood, broadleaf wood, or their combination, or from any other biomass such as sugarcane. The wood may originate from e.g. pine, poplar, beech, aspen, spruce, eucalyptus, ash, or birch. The wood may also be any combination or mixture of these.

In one embodiment, the lignin-based filler is prepared from lignin derived from enzymatic hydrolysis process and/or from a Kraft process and subjected to the hydrothermal carbonization treatment. In one embodiment, the lignin-based filler is prepared from lignin derived from enzymatic hydrolysis process and subjected to the hydrothermal carbonization treatment. In one embodiment, the lignin-based filler is prepared from lignin derived from a Kraft process and subjected to the hydrothermal carbonization treatment.

In one embodiment, the enzymatic hydrolysis process comprises enzymatic hydrolysis of a plant-based feedstock, such as a wood-based feedstock. In one embodiment, the enzymatic hydrolysis process comprises enzymatic hydrolysis of cellulose. In one embodiment, the lignin-based filler is prepared from lignin derived from pulping of wood, e.g. Kraft lignin.

The lignin-based filler may be prepared as disclosed below. The lignin to be used may be derived from e.g. a process wherein the lignin is formed in enzymatic hydrolysis of lignocellulosic feedstock or the lignin may be derived from a Kraft process. Also other lignin sources may be used.

In one embodiment, the starting material for preparing the lignin-based filler is lignin taken from enzymatic hydrolysis process. Enzymatic hydrolysis is a process, wherein enzyme(s) assist(s) in cleaving bonds in molecules with the addition of elements of water. In one embodiment, the enzymatic hydrolysis comprises enzymatic hydrolysis of cellulose. In one embodiment, the lignin-based filler is prepared from lignin derived from enzymatic hydrolysis process that is subjected to hydrothermal carbonization treatment.

The inventors surprisingly found out that when e.g. lignin from enzymatic hydrolysis process is used for producing the lignin-based filler, one is able to lower the ash content of the lignin-based filler. The lower ash content has the added utility of e.g. higher purity of the lignin-based filler.

The lignin may originate from second-generation biomass. The second-generation (2G) biomass may be taken to refer to non-edible and non-food biomass. Contrary to the term second-generation biomass, the first-generation biomass is to be taken as edible biomass.

The derived lignin may be dissolved in alkaline solution, such as NaOH. The dissolution may be accomplished by heating the mixture of lignin and alkaline solution to about 80° C., adjusting the pH to a value above 7, such as 9-11, and mixing the mixture of lignin and alkaline solution for a predetermined time. The mixing time may be continued for about 2-3 hours. The exact pH value is determined based on the grade target of the product.

The dissolved lignin may then be subjected to hydrothermal carbonization treatment (HTC).

The hydrothermal carbonization treatment may take place in a reactor (HTC reactor), or if needed, in several parallel reactors, working in a batchwise manner. The dissolved lignin may be pre-heated before being entered in the HTC reactor(s). The temperature in the HTC reactor(s) may be 150-250° C. and the pressure may be 20-30 bar. The residence time in the HTC reactor(s) may be about three to six hours. In the HTC reactor, the lignin is carbonized, whereby a stabilized lignin derivative with a high specific surface area may be precipitated. The formed slurry comprising the carbonized lignin may then be removed and cooled.

Consequently, a slurry comprising lignin-based filler is formed.

The slurry comprising lignin-based filler may be fed to a separation unit, wherein the precipitated lignin may be separated from the slurry. The separated lignin-based filler may be dried and recovered. Before drying, the lignin-based filler may be, if needed, washed. The recovered lignin-based filler may be treated further, e.g. crushed, dried further, milled etc. before using as the lignin-based filler. The thus formed lignin-based filler is a renewable and a biobased filler.

During the above-described process lignin polymers are connected to each other. Thus, the lignin-based filler may be considered to comprise or consist of lignin polymers that are linked together. Lignin polymers that are connected or linked together may not be soluble anymore. However, smaller lignin polymer chains still remain soluble and thus can be subjected to standard analytical techniques like size exclusion chromatography or nuclear magnetic resonance spectroscopy (NMR spectroscopy), which require the analyte to be dissolved in a solvent. Thus, different properties of the soluble fraction of the lignin-based filler may be determined.

The lignin-based filler may comprise ash in a total amount of 0.1-3 weight-%, or 0.1-2.5 weight-%, or 0.2-2.0 weight-%, or 0.3-1.5 weight-%, or 0.4-1.0 weight-%. The ash content can be determined according to the standard DIN 51719:1997-07. The inventors surprisingly found out that when e.g. lignin from enzymatic hydrolysis process is used for producing the lignin-based filler, one is able to lower the ash content of the lignin-based filler. The lower ash content has the added utility of e.g. higher purity of the lignin-based filler.

The lignin-based filler may comprise carbon in a total amount of 62-70 weight-%, or 63-69 weight-%, or 64-68 weight-%. The amount of carbon in the lignin-based filler may be determined according to standard DIN 51732 (1997).

The solubility of the lignin-based filler in 0.1 M NaOH may be 1-40 weight-%, or 3-35 weight-%, or 5-30 weight-%. The solubility may be measured in the following manner: First a sample is dried at a temperature of 60° C. for four hours. A sample mass of 0.5 gram is weighed and suspended in 50 ml of 0.1 M NaOH at a concentration of 1% having a temperature of 22° C. Mixing is continued for 1 hour, where after the sample is placed on a glass microfiber paper (1.6 μm) and the filter paper with the sample is dried at a temperature of 60° C. for 2 hours. The portion of the sample has which has dissolved can be determined gravimetrically.

The lignin-based filler may have a weight average molecular weight (Mw) of 1000-4000 Da, or 1300-3700 Da, or 1700-3200 Da, or 2500-3000 Da, or 2600-2900 Da, or 2650-2850 Da, when determined based on the soluble fraction of the lignin-based filler. The weight average molecular weight may be determined with size exclusion chromatography (SEC) by using 0.1 M NaOH as eluent and a sample amount of about 1 mg/ml, which is dissolved in 0.1 M NaOH. The molecular weights are measured against polystyrenesulfonate standards. UV detector at wavelength of 280 nm is used.

The polydispersity index (PDI) of the lignin-based filler may be 1.5-5.0, or 1.8-4.5, or 1.9-4.3, or 2.1-4.0, or 2.4-3.5, or 2.6-3.2, when determined based on the soluble fraction of the lignin-based filler. The polydispersity index may be determined by size-exclusion chromatography (SEC). The PDI is a measure of the distribution of molecular mass in a given polymer sample. The PDI is calculated as the weight average molecular weight (Mw) divided by the number average molecular weight (Mn). PDI indicates the distribution of individual molecular masses in a batch of polymers.

The lignin-based filler may have a STSA number of 3-150 m²/g, or 5-100 m²/g, or 7-60 m²/g. The STSA number may be determined according to standard ASTM D6556.

The lignin-based filler may have a density of at most 1.5 g/cm³. In one embodiment, the lignin-based filler has a density of 1.0-1.5 g/cm³, or 1.15-1.35 g/cm³, or 1.1-1.4 g/cm³. The density of the lignin-based filler may be determined according to standard ISO 21687.

The rubber composition as disclosed in the current disclosure has the added utility of having a high bio-based content and thus may be used to replace many fossil-based rubber compositions for different applications. The rubber composition thus may have a high share of renewable its components while simultaneously has properties such as hardness value similar to fossil-type rubber compositions. The rubber composition has the added utility of being a sustainable rubber composition, the use of which may reduce emissions compared to fossil-based rubber compositions.

### EXAMPLES

Reference will now be made in detail to the embodiments of the present disclosure.

The description below discloses some embodiments in such a detail that a person skilled in the art is able to utilize the method based on the disclosure. Not all steps of the embodiments are discussed in detail, as many of the steps will be obvious for the person skilled in the art based on this disclosure.

### Example 1—Producing Rubber Compositions

In this example rubber compositions were produced. The purpose was to evaluate the performance of using the renewable lignin-based filler (LBF) together with (bio-based) rubber and possibly also a (bio-based) plasticizer in different rubber compositions and to compare the same with rubber compositions prepared by using fossil components. Comparative examples were prepared by using carbon black or silica in the rubber compositions instead of the lignin-based filler. Fossil-based rubber and/or fossil-based plasticizer was used instead of bio-based rubber and/or bio-plasticizer in some of the (comparative) examples.

The lignin-based filler was prepared by following the description provided above in the current specification by using lignin material from enzymatic hydrolysis process of beech wood-based feedstock and subjected to hydrothermal carbonization treatment.

The rubber compositions were prepared in the following manner: In a first step, the rubber (EPDM), the lignin-based filler or carbon black, process oil (plasticizer), polyethylene glycol, stearic acid and zinc oxide were mixed using a laboratory kneader (interlocking internal mixers TMI 0.6 from ERMAFA) for 6.25 min. In the second mixing stage, the accelerators (MBT, ZDTP and TBzTD) and sulphur were added to the basic mixture, and everything was mixed for a total of four minutes. The mixtures were then sheeted and cured in a hydraulic press model LP3000 600 KN from MonTech Werkstoffprüfmaschinen GmbH at a temperature of 170° C. for t90+2 min.

The components used to prepare the rubber compositions and the properties measured for the produced rubber compositions are presented in the below table 1:

TABLE 1
Prepared rubber compositions and their properties

| Comparative | Comparative | Comparative | | Comparative | | Comparative | |
|---|---|---|---|---|---|---|---|
| example | example | example | example | example | example | example | example |
| 1 | 2 | 3 | 1 | 4 | 2 | 5 | 3 |

Composition recipes

| | | | | | | | | | |
|---|---|---|---|---|---|---|---|---|---|
| Components | Type | phr | phr | phr | phr | phr | phr | phr | phr |
| Ethylene | Keltan | 100 | 100 | 100 | 100 | — | —— | — | — |
| propylene | 8570C | | | | | | | | |
| diene | | | | | | | | | |
| monomer | | | | | | | | | |
| rubber | | | | | | | | | |
| (EPDM) | | | | | | | | | |
| fossil | | | | | | | | | |
| EPDM bio- | Keltan | — | — | — | — | 100 | 100 | 100 | 100 |
| based | Eco | | | | | | | | |
| | 5470 | | | | | | | | |
| Carbon | N550 | 115 | — | 115 | — | 115 | — | 115 | — |
| black | | | | | | | | | |
| Lignin- | UPM | — | 115 | — | 115 | — | 115 | — | 115 |
| based | Bio- | | | | | | | | |
| filler | chemicals | | | | | | | | |
| | GmbH | | | | | | | | |
| Fossil | Tudalen | 75 | 75 | — | — | 75 | 75 | — | — |
| oil | 1927 | | | | | | | | |
| (plasticizer) | | | | | | | | | |
| Bio-based | VIVA- | — | — | 75 | 75 | — | — | 75 | 75 |
| oil | B-FIX | | | | | | | | |
| (plasticizer) | 10245 | | | | | | | | |
| Polyethylene | PEG | 2 | 2 | 2 | 2 | 2 | 2 | 2 | 2 |
| glycol | 4000 | | | | | | | | |
| Stearic | Palmera | 2 | 2 | 2 | 2 | 2 | 2 | 2 | 2 |
| Acid | B1805 | | | | | | | | |
| Zinc | ZINKW | 5 | 5 | 5 | 5 | 5 | 5 | 5 | 5 |
| Oxide | EISS | | | | | | | | |
| | HANSA | | | | | | | | |
| | ULTRA | | | | | | | | |
| 2-Mercap- | Luvo- | 1 | 1 | 1 | 1 | 1 | 1 | 1 | 1 |
| tobenzo- | maxx | | | | | | | | |
| thiazol | MBT | | | | | | | | |
| (MBT) | | | | | | | | | |
| Zinc dial | Luvo- | 2 | 2 | 2 | 2 | 2 | 2 | 2 | 2 |
| kylphosph | maxx | | | | | | | | |
| orodithiloate | ZDTP | | | | | | | | |
| (ZDTP) | DL 73 | | | | | | | | |
| Tetra- | LUVO- | 1.05 | 1.05 | 1.05 | 1.05 | 1.05 | 1.05 | 1.05 | 1.05 |
| benzylthiuram | MAXX | | | | | | | | |
| disulfide | TBzTD | | | | | | | | |
| (TBzTD) | PEL- | | | | | | | | |
| | LETS | | | | | | | | |
| Sulfur | Struk | 1.5 | 1.5 | 1.5 | 1.5 | 1.5 | 1.5 | 1.5 | 1.5 |
| | tol | | | | | | | | |
| | SU 95 | | | | | | | | |

Composition properties

| | | | | | | | | | |
|---|---|---|---|---|---|---|---|---|---|
| Total | % | 3 | 33 | 23 | 59 | 25 | 61 | 47 | 86 |
| biogenic | | | | | | | | | |
| carbon | | | | | | | | | |
| content | | | | | | | | | |
| ts₂ 170° C.* | min | 0.68 | 1.46 | 0.72 | 1.55 | 0.7 | 1.61 | 0.77 | 1.67 |
| t₉₀ 170° C.* | min | 6.97 | 11.36 | 13.21 | 22.76 | 6.6 | 11.65 | 15.18 | 7.95 |
| ML 170° C.* | dNm | 1.65 | 1.22 | 1.48 | 1.07 | 1.39 | 0.85 | 1.24 | 0.76 |
| MH 170° C.* | dNm | 15.7 | 12.62 | 17.97 | 9.28 | 15.08 | 11.87 | 17.4 | 8.28 |
| ML (1 + 4) | MU | 49.3 | 41.6 | 41.2 | 36.9 | 41.9 | 34.3 | 36.4 | 30.9 |
| 100° C. | | | | | | | | | |
| Density | g/cm³ | 1.119 | 1.035 | 1.100 | 1.019 | 1.120 | 1.033 | 1.100 | 1.018 |
| Hardness, | | 63.7 | 58.2 | 62.6 | 56.3 | 62.9 | 58.1 | 64.0 | 57.4 |
| Shore A RT | | | | | | | | | |
| Rebound RT | % | 49.7 | 63.1 | 51.7 | 56.7 | 49.5 | 57.2 | 51.7 | 61.8 |
| Ashcontent | % | 2.0 | 2.8 | 2.0 | 2.8 | 2.0 | 2.8 | 2.0 | 2.8 |

ML = minimum torque
MH = maximum torgue
tₛ₂ = induction time
t₉₀ = optimum cure time
RT = room temperature
Test methods used:
*MDR: ASTM D 5289-19a
Mooney viscosity (MU) : ASTM D 1646-19a
Density: ASTM D792-20
Hardness: ASTM D 2240-15 (2021)
Ash content: DIN 51719:1997-07
Total biogenic carbon content: ASTM D6866-22

From the above table 1 one may see that the rubber composition of examples 1, 2, and 3 exhibits equally good properties as fossil-based composition, while simultaneously exhibiting a high bio-based carbo content.

### Example 2—Producing Rubber Compositions

In this example rubber compositions were produced. The purpose was to evaluate the performance of using the renewable lignin-based filler (LBF) in different rubber compositions. Comparative examples were prepared by using carbon black or silica in the rubber compositions instead of the lignin-based filler.

The lignin-based filler was prepared by following the description provided above in the current specification by using lignin material from enzymatic hydrolysis process of beech wood-based feedstock and subjected to hydrothermal carbonization treatment.

The rubber compositions were prepared in the following manner; In a first step, the natural rubber (NR), the lignin-based filler or carbon black or silica, antioxidant, stearic acid and zinc oxide were mixed using a laboratory kneader (interlocking internal mixers TMI 0.6 from ERMAFA) for 5.75 min. In the second mixing stage, the accelerator (CBS) and sulphur were added to the basic mixture, and everything was mixed for a total of 4.5 minutes. The mixtures were then sheeted and cured in a hydraulic press model LP3000 600 KN from MonTech Werkstoffprüfmaschinen GmbH at a temperature of 150° C. for t90+2 min.

The components used to prepare the rubber compositions and the properties measured for the produced rubber compositions are presented in the below table 2:

TABLE 2
Prepared rubber compositions and their properties

| Com- | Com- | |
|---|---|---|
| parative | parative | |
| example | example | Example |
| 1 | 2 | 1 |

Composition recipes

| | | | | |
|---|---|---|---|---|
| Components | Type | phr | phr | phr |
| Natural | SVR CV60 VRG | 100 | 100 | 100 |
| rubber | | | | |
| Carbon black | N550 | 50 | — | — |
| Silica | Ultrasil 360 | — | 50 | — |
| Lignin-based | UPM | — | — | 50 |
| filler | Biochemicals | | | |
| | GmbH | | | |
| Antioxidant | LUVOMAXX TMQ | 1 | 1 | 1 |
| Stearic Acid | Palmera B1805 | 2 | 2 | 2 |
| Zinc Oxide | ZINKWEISS | 5 | 5 | 5 |
| | HANSA ULTRA | | | |
| N-Cyclo- | MIXLAND+ ® CBS | 1.2 | 1.2 | 1.2 |
| hexylbenzo- | 75-80 | | | |
| thiazol-2- | BA/GA/SGA | | | |
| sulfenamide | | | | |
| (CBS) | | | | |
| Sulfur | Struktol SU | 1.5 | 1.5 | 1.5 |
| | 95 | | | |

Composition properties

| | | | | |
|---|---|---|---|---|
| Total bio- | % | 64 | 98 | 100 |
| genic carbon | | | | |
| content | | | | |
| ts2 170° C. * | min | 6.9 | 15.9 | 14.4 |
| t90 170° C. * | min | 12.8 | 21.3 | 22.3 |
| ML 170° C. * | dNm | 1.9 | 2.1 | 2.0 |
| MH 170° C. * | dNm | 15.6 | 9.3 | 10.4 |
| ML (1 + 4) | MU | 55.7 | 59.8 | 57.4 |
| 100° C. | | | | |
| Density | g/cm³ | 1.128 | 1.130 | 1.052 |
| Hardness, | | 61.2 | 47.8 | 50.1 |
| Shore A RT | | | | |
| Rebound RT | % | 71.4 | 73.5 | 76.5 |
| Ash content | % | 3.4 | 34 | 4.0 |

ML = minimum torque
MH = maximum torgue
tₛ₂ = induction time
t₉₀ = optimum cure time
RT = room temperature
Test methods used:
* MDR: ASTM D 5289-19a
Mooney viscosity (MU): ASTM D 1646-19a
Density: ASTM D792-20
Hardness: ASTM D 2240-15 (2021)
Ash content: DIN 51719: 1997-07
Total biogenic carbon content: ASTM D6866-22

From the above results one may see that a rubber composition with high biobased share together with good performance may be prepared. The rubber compositions formed by using the lignin-based filler further has a light weight (low density).

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A rubber composition and an article as disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A rubber composition, which is made by using at least lignin-based filler and rubber, and optionally plasticizer, wherein:
the lignin-based filler is prepared from lignin subjected to hydrothermal carbonization treatment;
the total amount of lignin-based filler in the rubber composition is 2-500 phr; and
the total biogenic carbon content of the rubber composition is 50-100% as determined according to standard ASTM D6866-22,
with the proviso that when no plasticizer is used for making the rubber composition, then at least one bio-based rubber is used; and when both rubber and plasticizer are used for making the rubber composition, then at least one bio-based rubber and/or at least one bio-based plasticizer is used.

2. The rubber composition of claim 1, wherein the proviso is that:
i) when no plasticizer is used for making the rubber composition, then the rubber comprises bio-based rubber; and
ii) when plasticizer is used for making the rubber composition, then:
the rubber comprises bio-based rubber and the plasticizer comprises bio-based plasticizer, or
the rubber comprises bio-based rubber and the plasticizer comprises fossil-based plasticizer, or
the rubber comprises fossil-based rubber and the plasticizer comprises bio-based plasticizer.

3. The rubber composition of claim 1, wherein the rubber composition is made by using at least lignin-based filler, bio-based rubber, and bio-based plasticizer.

4. The rubber composition of claim 1, wherein the weight ratio of the total amount of plasticizer to the total amount of rubber is 0-2.

5. The rubber composition of claim 1, wherein the bio-based plasticizer is selected from bio-based oil, bio-based wax, or bio-based liquid polymer.

6. The rubber composition of claim 1, wherein the total amount of lignin-based filler in the rubber composition is 5-200 phr.

7. The rubber composition of claim 1, wherein the weight ratio of the total amount of plasticizer to the total amount of lignin-based filler is 0-40.

8. The rubber composition of claim 1, wherein the rubber composition exhibits a hardness value of 20-100, as determined according to standard ASTM D 2240-15 (2021).

9. The rubber composition of claim 1, wherein rubber composition exhibits a Mooney viscosity ML (1+4) 100° C. of 20-110 MU, as determined according to standard ASTM D 1646-19a.

10. The rubber composition of claim 1, wherein the total biogenic carbon content of the rubber composition is total biogenic carbon content of the rubber composition may be 50-99%, as determined according to standard ASTM D6866-22.

11. The rubber composition of claim 1, wherein the total organic carbon content of the rubber composition is 30-100%, as determined according to DIN EN 15936:2012-11.

12. The rubber composition of claim 1, wherein the ash content of the rubber composition is less than 25 weight-% as determined according to DIN 51719: 1997-07.

13. The rubber composition of claim 1, wherein the rubber is selected from ethylene propylene diene monomer rubber (EPDM), ethylene propylene rubber (EPR), butadiene rubber (BR), styrene-butadiene rubber (SBR), epichlorhydrin rubber (ECO), chloroprene rubber (CR), natural rubber (NR), epoxidized natural rubber (ENR), butyl rubber (IIR), isoprene rubber (IR), acrylonitrile-butadiene rubber (NBR), hydrogenated nitrile rubber (HNBR), bromobutyl rubber (BIIR) chlorobutyl rubber (CIIR) or any combination or mixture thereof.

14. The rubber composition of claim 1, wherein the lignin originates from second-generation biomass.

15. An article comprising a rubber composition, the rubber composition being made by using at least lignin-based filler and rubber, and optionally plasticizer, wherein:
the lignin-based filler is prepared from lignin subjected to hydrothermal carbonization treatment;
the total amount of lignin-based filler in the rubber composition is 2-500 phr; and
the total biogenic carbon content of the rubber composition is 50-100% as determined according to standard ASTM D6866-22,
with the proviso that when no plasticizer is used for making the rubber composition, then at least one bio-based rubber is used; and when both rubber and plasticizer are used for making the rubber composition, then at least one bio-based rubber and/or at least one bio-based plasticizer is used.

16. The article of claim 15, wherein the article is a profile, a hose, a sealing, an O-ring, a weather strip, a gasket, a tubing, a membrane, an insulator, a cable, a wiper blade, a bushing, a tape, a foil, a lining, a flooring, a plug, a nipple, a conveyor belt, a seal or a tire.
